(19) United States
(12) Patent Application Publication
(10) Pub. No.: US 2009/0280462 A1
(43) Pub. Date: Nov. 12, 2009

(54) Systems and methods for goal attainment in post-graduation activities

(76) Inventor: David Yaskin, Arlington, VA (US)

Correspondence Address: MCDERMOTT, WILL & EMERY, 11682 EL CAMINO REAL, SUITE 400, SAN DIEGO, CA, 92130-2047, US

(21) Appl. No.: 12/151,580

(22) Filed: May 6, 2008

(51) Int. Cl. G09B 3/00

(52) U.S. Cl. 434/322

(57) ABSTRACT

Systems and methods are provided for electronically correlating pre-graduation student interactions with one or more post-graduation outcomes. The systems and methods comprise capturing pre-graduation student interaction data and capturing post-graduation student data. The systems and methods determine one or more post-graduation outcomes from the captured post-graduation student data, and correlate the pre-graduation student interaction data elements with the one or more post-graduation student outcomes. The systems and methods determine which captured pre-graduation student interaction data elements and/or post-graduation student data elements have increased correlation with the one or more post-graduation outcomes. Factor analysis may be used to determine which pre-graduation and/or post-graduation captured data elements have an increased correlation with the post-graduation outcomes.

### FIELD

The present disclosure generally relates to computer software and hardware systems, and, in particular, relates to systems and methods for correlating factors with post-graduation student outcomes.

### BACKGROUND

Presently, educational institutions have various goals for students that relate to student learning outcomes. These institutions often strive to build a campus that encourages learning both inside and outside the classroom, as well as foster personal growth. The physical campus, co-curricular activities, extra-curricular activities, campus computer networks that foster on-line communities, and other services typically contribute to achieving learning outcomes. Educational institutions increasingly endeavor to offer many academic programs as well as diverse, creative activities as part of an interdisciplinary approach to education.

Educational institutions, however, find it difficult to determine which factors of a student's overall experience significantly contribute to a student achieving a post-graduation outcome. Post-graduation outcomes can include graduate school entrance exam results, graduate schools applied and accepted to, graduate degrees obtained, professional licenses obtained, employment positions held, salaries received, and names of employers. It is equally difficult for an educational institution to determine which factors were detrimental to or created obstacles for the student in achieving post-graduation outcomes. Knowing which factors are helpful or harmful for a student in achieving post-graduation outcomes is desirable in fostering a pre-graduation educational environment to attract and retain students.

It is desirable for an educational institution to determine which events, activities, or experiences that a student experienced while attending the educational institution have increased correlation with achievement of post-graduation student outcomes. Accordingly, there exists a need for systems and methods to correlate captured pre-graduation and/or post-graduation data with post-graduation outcomes.

### SUMMARY

Exemplary embodiments provide systems and methods for correlating pre-graduation student interaction data and/or post-graduation student data with post-graduation outcomes. During a time period that may include at least a portion of a pre-graduation time period, a student identification card, an electronic device, and/or universal account may be associated with a student that may contain student data or other student information. The card or device may be swiped, read by a proximity reader, engaged in an interchange of information based on a received request, or be subject to any other registration by the system. This swiping or interchange of information may provide a record of, for example, how frequently a student attended class, visited the library, utilized entertainment offerings on- or off-site from an educational campus, participated in educational online organizations, attended educational events or lectures outside of class, attended cultural events, utilized off-campus merchants, or any other suitable activities. Alternatively, student information data may be captured at a login event for an educational institution computer network, or with the submission of an electronic document for educational or administrative purposes. Such data may be captured and stored on at least one digital storage device while a student is attending an educational institution.

The system may additionally enable capturing of data by interfacing with applications and related databases that provide post-graduation student survey data. The data may include, for example, employment positions attained, salary data, graduate school acceptance rate, graduate schools accepted to, graduate schools being attended, graduate degrees granted, or any other suitable information, or combination thereof. Additionally, this data may be captured by the system, for example, by enabling student self-reporting of information.

The capturing of data by interfacing with applications and related databases includes both internal systems (i.e., those systems within the institution) and external systems. Examples of external systems include admission systems of other universities (e.g., for reporting on who applied and who was accepted into a graduate school), testing results systems (such as GMAT, LSAT, etc.), and the human resources systems of employers. These are but examples, as other external systems can connect and interface with the system of the present invention. In this manner, systems may provide information in addition to relying on capturing self-reported information.

The exemplary systems and methods may enable factor analysis to determine which factors imparted increased levels of impact on particular post-graduation outcomes. For example, factor analysis may be used to determine which pre-graduation and/or post-graduation captured data elements had an increased correlation with post-graduation outcomes.

Systems and methods are provided for electronically correlating pre-graduation student interactions with one or more post-graduation outcomes. The systems and methods comprise capturing pre-graduation student interaction data and capturing post-graduation student data. The systems and methods determine one or more post-graduation outcomes from the captured post-graduation student data and correlate the pre-graduation student interaction data elements with the one or more post-graduation student outcomes. The systems and methods determine which captured pre-graduation student interaction data elements and/or post-graduation student data elements have increased correlation with the one or more post-graduation outcomes. Factor analysis may be used to determine which pre-graduation and/or post-graduation captured data elements have an increased correlation with the post-graduation outcomes.

The disclosure also encompasses program products for correlating post-graduation student outcomes with captured student data of the type outlined above. In such a product, the programming is embodied in or carried on a machine-readable medium.

Additional features will be set forth in the description below, and in part will be apparent from the description, or may be learned by practice of the exemplary embodiments. The exemplary embodiments will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide further understanding of the exemplary embodiments and are incorporated in and constitute a part of this specification, illustrate embodiments and together with the description serve to explain the embodiments. In the drawings:

FIG. 1 illustrates an exemplary block-level diagram of an institutional environment in which a post-graduation student outcomes correlation system is implemented according to an exemplary embodiment;

FIG. 2 is a flow diagram for correlating pre-graduation student interactions with one or more post-graduation student outcomes according to an exemplary embodiment;

FIG. 3 illustrates a display that enables a user to view and access pre-graduation and post-graduation data according to an exemplary embodiment;

FIGS. 4A-4B depict displays indicating course-specific event information and course rubric information for a student according to an exemplary embodiment;

FIG. 4C illustrates an exemplary critical thinking rubric display for a student according to an exemplary embodiment;

FIG. 5 illustrates a display indicating student attendance or participation in various events according to an exemplary embodiment;

FIG. 6 depicts a display indicating post-graduation student information according to an exemplary embodiment;

FIG. 7 illustrates a display indicating pre-graduation and post-graduation data correlated with post-graduation outcomes for a student according to an exemplary embodiment; and

FIG. 8 illustrates a display indicating pre-graduation and post-graduation data correlated with post-graduation outcomes for a plurality of students according to an exemplary embodiment.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

As generally used herein, the term “goals” provide guidance on areas that should be addressed through specific, measurable objectives. The term “outcome” is the achieved result or consequence of some activity (e.g. instruction or some other performance). Frequently, the term is used with a modifier to clarify the activity. For example a “post-graduation outcome” is an outcome that is the achieved result or consequence of an activity that occurred after graduation from an educational institution.

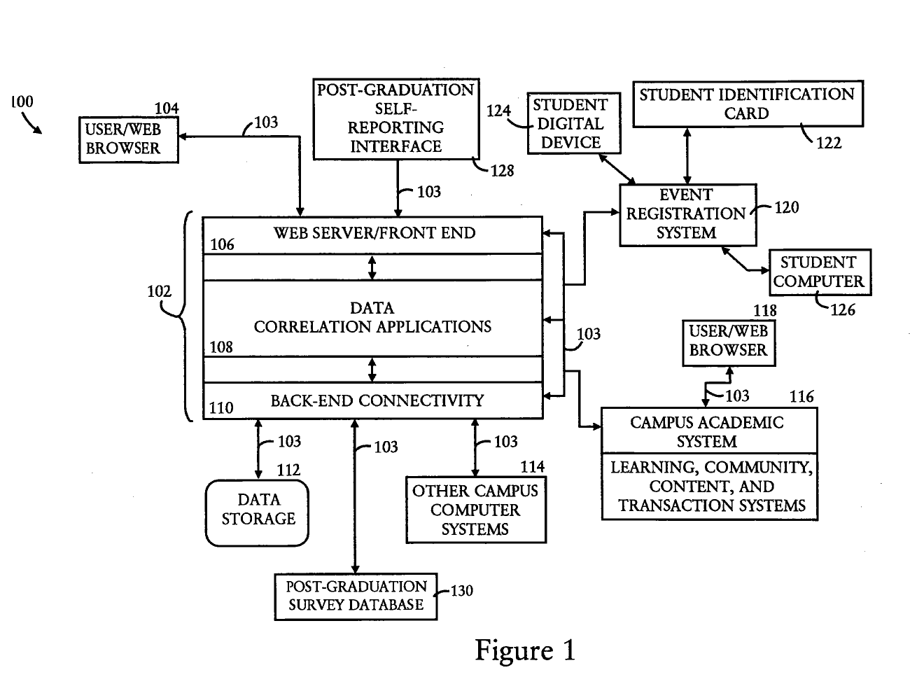

FIG. 1 depicts a functional block diagram of an exemplary data correlation system 100. As described in more detail herein, data correlation system 100 may provide a framework for performing post-graduation outcome analysis as related to pre-graduation achievement of learning and participation in activities by students in, for example, an educational institution. Computing system 102 may be one or more computers (e.g., one or more servers, personal computers, minicomputers, mainframe computers, or any other suitable computing devices, or any combination thereof) that may be configured with front-end 106, data correlation applications 108, and back-end connectivity 110.

User computer 104 may be configured to communicate with computer system 102 via a web browser or similar interface to communicate with an appropriately configured front-end 106 of system 102. Communication between user computer 104 and front end 106 of computer system 102 may be via communications link 103, which may be a wireless or wired communications link such as a local area network, wide area network, the Internet, or any other suitable communications network. Front-end 106 may be, for example, a web server or other computing device hosting one or more data correlation applications 108 that user computer 104 may access. Applications 108 may be one or more software components or programs that execute on a programmable computer platform of computer system 102 to provide functionality related to correlating post-graduation outcomes with pre-graduation and/or post-graduation data. Such applications 108 may include components for capturing data related to pre-graduation and/or post-graduation events, capturing data related to post-graduation outcomes, determining which captured pre-graduation and/or post-graduation data elements have increased correlation with post-graduation outcomes, or any other suitable components, or any combination thereof.

Computing system 102 may also access data storage facilities 112 and other computer systems 114 via communications link 103. For example, data storage facilities 112 may be one or more digital data storage devices configured with one or more databases having student data (e.g., student identification number, student name, student gender, student race, courses completed, courses enrolled in, degree program, certificate program, etc.) and may also contain data received from a registration event with a student identification card, device configured with student information, and/or from registering an event by which a student entered identification data (e.g., a login event to a educational institution computer network application using student identification information). Data storage facilities 112 may store and arrange data in a convenient and appropriate manner for manipulation and retrieval. Other computer systems 114 may be a variety of third-party systems that contain data or resources that are useful for the student performance assessment system 100. In the exemplary higher education environment, systems 114 may include a student information system (SIS) that maintains student demographic information. Systems 114 may also include an electronically maintained class or course schedule for the institution that includes information about the courses such as section numbers, professors, class size, department, college, the students enrolled, etc. Other campus-related systems such as financial aid and the bursar's office may be included in systems 114 of FIG. 1.

Back-end connectivity 110 of computer system 102 may be appropriately configured software and hardware that interface between data correlation applications 108 and resources including, but not limited to, data storage 112 and other computer systems 114 via communications link 103.

Another resource to which the back end 110 may provide connectivity (e.g., via communications link 103) is a campus (or institutional) academic system 116. Campus academic system 116, in an academic environment, provides a platform that allows students and teachers to interact in a virtual environment based on the courses for which the student is enrolled. This system may be logically separated into different components such as a learning system, a content system, a community system, or a transaction system, or any other suitable system, or any combination thereof. For example, a student, administrator, faculty or staff member may operate user computer 118 to access academic system 116 via a web browser or similar interface.

Of particular usefulness to system 100, academic system 116 may provide a virtual space that user computer 118 may access to receive information and to provide information. One exemplary arrangement provides user computer 118 with a webpage where general information may be located and that has links to access course-specific pages where course-specific information is located. Electronic messaging, electronic drop boxes, and executable modules may be provided within the user's virtual space on the academic system 116. Thus, with respect to computer system 102, one of applications 108 may be used to generate information that is to be deployed to one or more users of academic system 116. Via back-end 110, the information may be sent to academic system 116 where it is made available to user computer 118 just as any other information may be made available. Similarly, from within the academic system 116, the user may enter and submit data that is routed through the back end 110 to one of the applications 108. Academic system 116 and computer system 102 may be more closely integrated so that the connectivity between the applications 108 and the system 116 is achieved without a network connection or back end software 110.

System 102 may be communicatively coupled to one or more registration systems 120, which may be a card reader, proximity reader, or other suitable system configured to capture information from student identification card 122, student digital device 124 (e.g., cellular phone, personal digital assistant, handheld computing device, laptop computer, etc.), or student computer 126. Although only one student identification card 122, student digital device 124, and student computer 126 are shown, there may be one or more of each respective device that may communicate with registration system 120. Identification card 122, digital device 124, and/or student computer 126 may be configured with student identification information (e.g., student name, student identification number, gender, race, major, dining services plan, etc.). For example, student identification card 122 may be swiped, scanned, or registered by proximity by registration system 120 at an event (e.g., student attending class, cultural event, entertainment event, athletic event, etc.) to capture and associate attendance by the student at the particular event. Alternatively, student digital device 124 may communicate student identification information via a wired or wireless communications link with registration system 120 at an event. Also, student computer 126 may communicate with registration system 120 to provide student information at a login event or other information exchange event (e.g., electronic homework assignment submission by a student, wherein registration system captures the student identification information, as well as one or more data elements regarding the course and the assignment submission, etc.). Data captured by registration system 120 may be transmitted to computer system 102 via communications link 103 for processing (e.g., by applications 108, etc.) and/or storage (e.g., stored in data storage 112, etc.).

Data may be captured from student identification card 122 or student digital device 124 related to presence, utilizations, and transactions by a student. For example, a student may use card 122 or device 124 to purchase a ticket for a concert for the city symphony or a ticket for an exhibit at the city art museum. Card 122 or device 124 may be enabled with banking account, declining balance account, or credit card account information, or other financial transaction enabling information to facilitate the purchase of the tickets. Additionally, attendance of the symphonic concert or art museum exhibit by the student may be registered by registration system 120, which may be present at the city symphonic hall where the concert is being performed or at the art museum in order to receive student identification data and event information data (e.g., concert information, location of symphony hall, time of attendance, etc.) from the swiping or registering of student identification card 122 or device 124.

In another example, a student may use card 122 or device 124 to purchase a bus ticket or bus pass from the city's transportation authority. Again, card 122 or device 124 may also be enabled with banking account, declining balance account, or credit card account information, or other financial transaction enabling information to facilitate the purchase of the bus ticket (e.g., single ride, round-trip, etc.) or bus pass (e.g., 2 ride pass, 4 ride pass, weekly pass, weekend pass, monthly pass, academic year pass, year pass, etc.). Alternatively, a student may purchase a bus pass or ticket with card 122 or device 124, and information related to the pass or ticket may be associated with card 122 or device 124. Upon using the bus with card 122 or device 124 having associated bus pass or ticket information, the bus may be equipped with at least a portion of registration system 120 to register student use of the bus (e.g., identification information of the student, bus route information, time used, etc.) and may deduct from the bus use allowance of the purchased bus ticket or pass (e.g., deduct a day of use from the weekly pass purchased from the student's account, etc.).

In yet another example, a student may use card 122 or device 124 to purchase a pizza from an off-campus merchant, or purchase a Calculus study guide from the on-campus bookstore. During the purchasing transaction, card 122 may be swiped or read by a proximity reader (e.g., event registration system 120), and data may be captured such as the identity of the student, the location of the purchase (e.g., name and location of off-campus vendor), and data related to the items that were purchased (e.g., large pepperoni pizza; title, author, and publisher of the Calculus study guide purchased; cost of the items, etc.). Card 122 or device 124 may also be enabled with banking account, declining balance account, or credit card account information, or other financial transaction enabling information to facilitate the purchase of the items. In another example, student computer 126 may be used in an on-line purchasing transaction with an on-line merchant, wherein the student identification, information related to the items purchased, and information related to the on-line vendor may be captured by event registration system 120 (e.g., student computer 126 may transmit the information to event registration system 120 after the transaction).

Event registration system 120 may capture presence and utilization data by capturing data from student identification card 122, digital data device 124, and/or student computer 126 at particular events. For example, card 122 may be scanned (e.g., using event registration system 120) at the entrance of the educational institution's library (e.g., card 122 may be scanned at the entrance and exit of the library to record the times associated with entering and leaving), and may be scanned again when a student checks out a book. Thus, event registration system 120 may capture data related to the identity of the student, as well as the duration of time that the student was in the library, and information related to the book that the student checked out (e.g., author, title, genre, etc.). Similar registration of card 122 or device 124 by event registration system 120 may occur, for example, if the student attends a sporting event (e.g., a football game, etc.) or a cultural event such as a music concert (e.g., concert by string quartet, chamber orchestra, jazz band, etc.).

Post-graduation self-reporting interface 128 may be configured on a computing device (e.g., personal computer, laptop computer, personal digital assistant, cell phone, etc.) or may be accessed from front end 106 of computer system 102 by a computing device via a web browser. Post-graduation self-reporting interface 128 may enable a user to provide data related to post-graduation events including, but not limited to: graduate school entrance exams taken (e.g., Graduate Record Examination (GRE), Law School Admission Test (LSAT), Medical College Admission Test (MCAT), Graduate Management Admission Test (GMAT), etc.); graduate school entrance exam score(s) received; graduate school(s) applied to; graduate school(s) accepted to; graduate school(s) attended; graduate degree(s) granted; professional license(s) obtained; employers during the post-graduation period; employment positions held post-graduation; salaries received post-graduation; period of time to find employment post-graduation; current home address; or any other suitable information.

Computer system 102 may capture post-graduation student data by interfacing with databases such as post-graduation database 130 and/or applications accessible via communications link 103. Database 130 may contain data captured via one or more surveys, wherein the data may be related to post-graduation events, including, but not limited to: graduate school entrance exams taken (e.g., GRE, LSAT, MCAT, GMAT, etc.); graduate school entrance exam score(s) received; graduate school(s) applied to; graduate schools accepted to; graduate school(s) attended; graduate degree(s) granted; professional license(s) obtained; employers during the post-graduate period; employment positions held post-graduation; salaries received post-graduation; period of time to find employment post-graduation; current home address; or any other suitable information.

Although front end 106, applications 108, and back end 110 of the computer system 102 are each depicted as a single block in FIG. 1, one of ordinary skill will appreciate that each may also be implemented using a number of discrete, interconnected components. As for the communication links between the various blocks of FIG. 1, a variety of functionally equivalent arrangements may be utilized. For example, some links may be via the Internet or other wide-area network, while other links may be via a local-area network or even a wireless interface. Also, although only a single computer 104 of computer system 102 is explicitly shown, multiple users and multiple computers or computing devices may be utilized in system 100. The structure of FIG. 1 is logical in nature and does not necessarily reflect the physical structure of such a system. For example, computer system 102 may be distributed across multiple computer platforms as can the data storage 112. Furthermore, components 106, 108, 110 are separate in the figure to simplify explanation of their respective operation. However, these functions may be performed by a number of different, individual components, or a more monolithically arranged component. Additionally, any of the three logical components 106, 108, 110 may directly communicate with the academic system 116 without an intermediary. Also, although the users 104, 118 are depicted as separate entities in FIG. 1, they may, in fact, be the same user or a single web browser instance concurrently accessing both computer system 102 and the academic system 116. Further, data storage 112 may be separate from, or included on, the assessment system 102.

Correlating pre-graduation and/or post-graduation data to determine correlations with post-graduation outcomes is a complex undertaking that encompasses many different levels of data collection and analysis. System 100 may be used to capture pre-graduation data from one or more sources from student participation in events and activities at an educational institution, capture post-graduation events and activities via surveys or self-reporting systems (or in the same manner as pre-graduation data), and correlate the pre-graduation and/or post-graduation data with post-graduation outcomes to determine which factors had an increased contribution to a former student attaining the post-graduation outcomes.

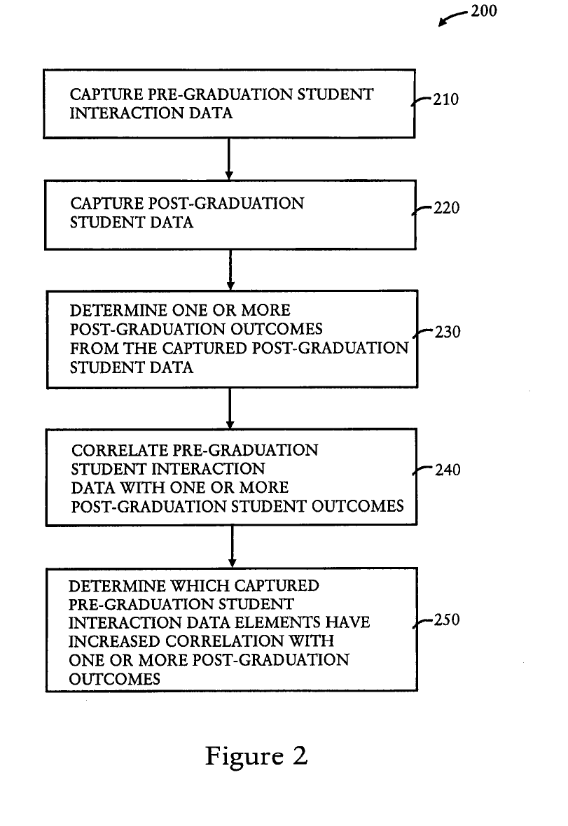

FIG. 2 depicts an exemplary diagram for flow 200 for correlating pre-graduation student interactions with one or more post-graduation outcomes. Computer system 102 (FIG. 1) configured with data correlation applications 108 may, for example, perform flow 200. At block 210, at least some pre-graduation student interaction data may be captured, where the captured data has one or more elements.

For example, system 100 may capture data (e.g., using registration system 120) related to pre-graduation student interaction data. The captured pre-graduation student interaction data at block 210 by registration system 120 may be presence data or non-presence data. The captured presence data may relate to, for example, how frequently a student has attended class, visited the library, utilized entertainment offerings on- or off-site from an educational campus, participated in educational online organizations, attended educational events or lectures outside of class, or any other suitable activities, or any combination thereof. Captured non-presence data may include, for example, student patronage of on-campus merchants, student patronage of off-campus merchants, student patronage of on-line merchants, student electronic submission of an assignment, or student electronic submission of student identification information, student utilization of an on-campus resource (e.g., checking out a library book, usage of a computer lab or athletic facility, etc.), student utilization of an off-campus resource, any transactional or utilization information, or any combination thereof.

Also, non-presence data may also include student data that may be requested and received by computer system 120 from various sources in system 100 (e.g., from campus academic system 116, data storage 112, and/or campus computer system 114 of FIG. 1). Student data may include, but is not limited to student demographic data, student degree program, student certificate program, courses completed, course type (e.g., on-line courses, distance learning courses, on-campus courses, summer courses, continuing education courses, etc.) courses needed for completion of the degree or certificate program, program rubric data, course rubric data, skills rubric data (e.g., critical thinking rubric data, communication rubric data, etc.), or any other suitable information, or any combination thereof. The student data may be stored, for example in data storage 112, other campus computer 114, campus academic system 116, or any other suitable digital storage device communicatively coupled to computer system 102.

At block 220, system 100 may capture post-graduation data from post-graduation self-reporting interface 128 and/or from post-graduation database 130. Additionally, post-graduation data may also be captured by event registration system 120. For example, a former student may continue to participate in on-line forums, and the former student's participation may be captured by event registration system 120 (e.g., student identifying information may indicate the student's participation in the forum), or a former student may continue to attend cultural events on- or off-campus (e.g., former student may have retained card 122 or device 124 which may be registered by event registration system 120, or the former student may be issued an alumni version of card 122 or device 124).

At block 230, system 100 may determine one or more post-graduation outcomes from the captured post-graduation student data at block 220. Exemplary post-graduation outcomes may include graduate school entrance exam results, graduate schools accepted to, graduate schools that declined acceptance, graduate degrees obtained, professional licenses obtained, employer names and locations, employment positions held, salaries, any other suitable data, or any combination thereof.

At block 240, system 100 may correlate at least some pre-graduation student interaction data elements captured at block 210 with one or more post-graduation outcomes determined at block 230. Computer 102 of system 100 may correlate one or more of the pre-graduation student interaction data elements with a post-graduation outcome. Alternatively, computer 102 may also correlate one or more pre-graduation student interaction data elements captured at block 210 and one or more post-graduation data elements captured at block 220 with a post-graduation outcome.

At block 250, computer system 102 of system 100 may determine which pre-graduation data elements have increased correlation with the one or more post-graduation outcomes determined at block 230. Exemplary post-graduation outcomes may include graduate school entrance exam results, graduate schools accepted to, graduate schools that declined acceptance, graduate degrees obtained, professional licenses obtained, employer names and locations, employment positions held, salaries, any other suitable data, or any combination thereof for an individual student or a plurality of students. System 102 may apply factor analysis, as described below, in order to determine which pre-graduation student interaction data elements have an increased correlation with the post-graduation outcomes. Alternatively, system 102 may apply factor analysis in order to determine which pre-graduation student interaction data elements and which post-graduation student data have an increased correlation with the post-graduation outcomes.

Factor analysis may be used by the exemplary systems described herein (e.g., system 100 of FIG. 1) as a statistical data reduction technique that may be used to explain variability among observed random variables in terms of fewer unobserved random variables (i.e., factors). The observed variables may be modeled as linear combinations of the factors. An advantage of factor analysis is the reduction of the number of variables by combining two or more variables into a single factor. Accordingly, factor analysis may be used for data reduction. For example, specific factors may be combined into a general, overarching factor such as academic performance. Another advantage of factor analysis is the identification of groups of inter-related variables to determine how they are related to each other. Thus, factor analysis may also be used as a structure detection technique. For example, student attendance of cultural events and participation in on-line educational community groups may relate to a post-graduation outcome of receiving a graduate degree, having a particular employment salary, or average time duration to finding post-graduation employment (e.g., increased attendance of cultural events and participation in on-line communities may be correlated with a decreased amount of time to secure post-graduation employment).

Correspondence analysis also may be performed by the exemplary systems as described herein. Correspondence analysis may be used, for example, to analyze two-way and multi-way tables containing one or more measures of correspondence between data (i.e., data in the rows and columns of the table). The results may provide information which is similar in nature to those produced by factor analysis techniques. The structure of categorical variables included in the table may be identified and summarized for presentation to a user (e.g., administrator, faculty member, etc.).

In using factor analysis as a variable reduction technique, the correlation between two or more variables may be summarized by combining two variables into a single factor. For example, two variables may be plotted in a scatterplot. A regression line may be fitted (e.g., by computer system 102 of FIG. 1) that represents a summary of the linear relationships between the two variables. For example, if there are two variables, a two-dimensional plot may be performed, where the two variables define a plane. With three variables, a three-dimensional scatterplot may be determined, and a plane could be fitted through the data. With more than three variables it becomes difficult to illustrate the points in a scatterplot, but the analysis may be performed by computer system 102 to determine the regression summary of the relationships between the three or more variables. A variable may be defined that approximates the regression line in such a plot to capture the principal components of the two or more items. Data scores from student data on the new factor (i.e., represented by the regression line) may be used in future data analyses to represent that essence of the two or more items. Accordingly, two or more variables may be reduced to one factor, wherein the factor is a linear combination of the two or more variables.

The extraction of principal components may be found by determining a variance maximizing rotation of the original variable space. For example, in a scatterplot, the regression line may be the original X-axis, rotated so that it approximates the regression line. This type of rotation is called variance maximizing because the criterion for (i.e., goal of) the rotation is to maximize the variance (i.e., variability) of the “new” variable (factor), while minimizing the variance around the new variable. Although it is difficult to perform a scatterplot with three or more variables, the logic of rotating the axes so as to maximize the variance of the new factor remains the same.

After a line has been determined on which the variance is maximal, some variability remains around this first line. Upon extraction of the first factor (i.e., after the first line has been drawn through the data), another line may be defined that maximizes the remaining variability. In this manner, consecutive factors may be extracted. Because each consecutive factor is defined to maximize the variability that is not captured by the preceding factor, consecutive factors are independent of each other. Thus, consecutive factors are uncorrelated or orthogonal to each other.

In applying principal component analysis as a data reduction method (i.e., a method for reducing the number of variables), the number of factors desired to be extracted may be selected. As consecutive factors are extracted, the factors may account for decreasing variability. One method to determine when to stop extracting factors may depend on when the “random” variability has significantly decreased (i.e., very little random variability left). A correlation matrix may be used to determine the variance amongst each of the variables. The total variance in that matrix may be equal to the number of variables.

In contrast to the variable reduction methods of principal component analysis described above, principal factor analysis may also be performed by computer system 102 of FIG. 1 to determine the structure in the relationships between variables. The student data may be used to form a “model” for principal factor analysis. For example, the student data may be dependent on at least two components. First, there may be one or more underlying common factors. Each item may measure some part of this common aspect. Second, each item may also capture a unique aspect (of the common aspect) that may not be addressed by any other item.

If this model is correct, the factors may not extract substantially all variance from the items. Rather, only that proportion that is due to the common factors and shared by several items may be extracted. The proportion of variance of a particular item that is due to common factors (shared with other items) is called communality. The communalities for each variable may be estimated (i.e., the proportion of variance that each item has in common with other items). The proportion of variance that is unique to each item may then the respective item's total variance minus the communality. A common starting point is to use the squared multiple correlation of an item with all other items as an estimate of the communality. Alternatively, various iterative post-solution improvements may be made to the initial multiple regression communality estimate.

A characteristic that distinguishes between the two factor analytic models described above is that in principal components analysis (i.e., factor reduction) may assume that substantially all variability in an item should be used in the analysis, while principal factors analysis (i.e., structure detection) may use the variability in an item that it has in common with the other items. In most cases, these two methods usually yield very similar results. However, principal components analysis is often preferred as a method for data reduction, while principal factors analysis is often preferred when the goal of the analysis is to detect structure.

Computer system 102 of FIG. 1 configured with factor analysis applications programming (e.g., as part of applications 108) may identify which data elements (e.g., pre-graduation student interaction data, post-graduation student data, etc.) had increased significance with a former student achieving one or more post-graduation outcomes. System 102 may use quantitative techniques, such as data gathering from registration system 120 (e.g., swipes of student identification card 122, proximity readings of card 122, registration of digital device 124 configured with student information, capturing student identification information entered from student computer 126, capturing data from post-graduation self-reporting interface 128, capturing data from post-graduation student survey database 130, etc.) to collect data about a student concerning their attendance and participation in various pre-graduation, post-graduation, or pre- and post-graduation events, or utilization of resources. The captured data (taken alone or in combination with other student data that may be stored, e.g., with campus academic system 116) may be used as input for a statistical application (e.g., applications 108) of computer system 102 of FIG. 1, which may process the data using factor analysis. System 102 may yield a set of underlying attributes (i.e., factors). Upon determination of the factors, system 102 may construct perceptual maps, graphs, or other textual or visual output to indicate the correlation of particular factors and student achievement of one or more defined goals. System 102 may present such maps, graphs, and/or text in displays for presentation to, for example, a administrator, a faculty member, or any other suitable person using computer 104 or 118.

Computer system 102 may be configured with programming that is executed to perform factor analysis on one or more elements of data to isolate underlying factors that summarize the resultant information as it relates to attainment of one or more student goals. The factor analysis may be an interdependence technique, wherein one or more sets of interdependent relationships may be examined. The factor analysis may reduce the rating data on different attributes to a few important dimensions (e.g., whether the student goal was achieved, and which activities had increased influence in goal completion). This reduction is possible because the attributes are related (e.g., the post-graduation student data relates to the post-graduation student outcome; the pre-graduation student interaction data relates to the achievement of post-graduation student outcomes, etc.). The rating given to any one attribute is partially the result of the influence of other attributes. Thus, system 102 may determine which activities, events, or resource utilizations in which a student participated in pre-graduation had the most influence in a post-graduation student achieving a post-graduation outcome. System 102 may also determine which pre-graduation interaction data and post-graduation student data correlates with one or more post-graduation student outcomes. The statistical programming (e.g., application 108) implemented on system 102 may deconstruct the rating (i.e., raw score) into one or more components, and reconstruct the partial scores into underlying factor scores. The amount of correlation between the initial raw score and the final factor score is referred to as factor loading.

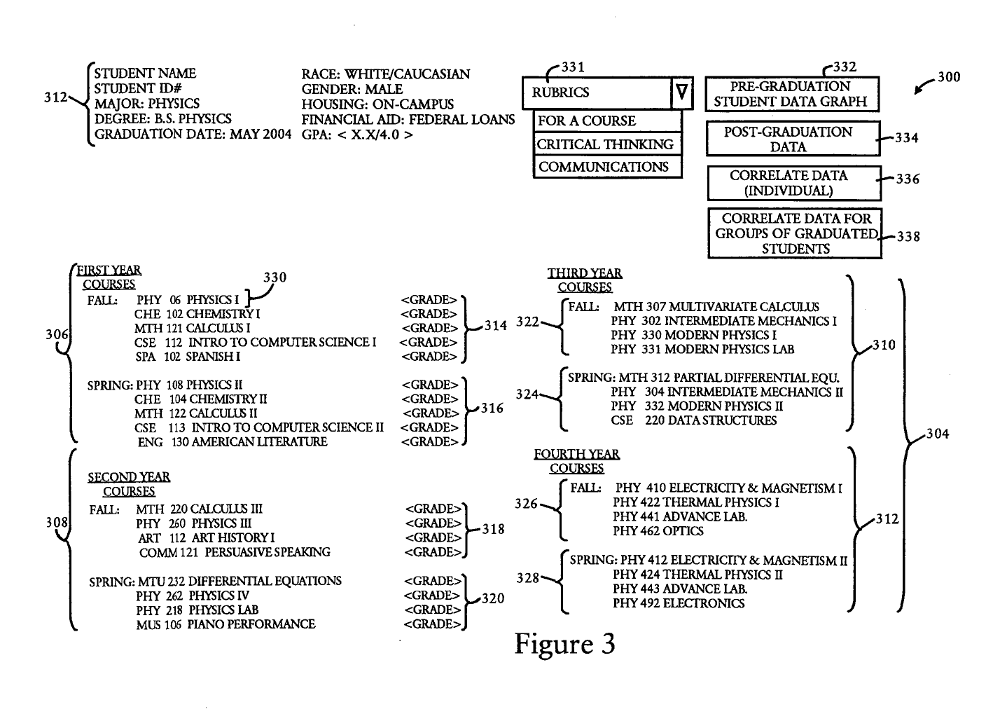

FIG. 3 illustrates an exemplary display 300 that computer system 102 may present to a user (e.g., administrator, etc.) to provide pre-graduation and post-graduation student data, and enable correlation of data using, for example, factor analysis as described above. Display 300 may provide student information 302, which may provide information related to the student who attended a particular educational institution. Student information 302 may include student name, identification number, gender, graduation date, race, certificate or degree program, certificate or degree granted, graduation date, dates of attendance, financial aid received (e.g., loans, grants, scholarships, work-study program, etc.), or housing status during attendance (e.g., on-campus housing, off-campus housing, etc.), or any combination thereof, or any other suitable information.

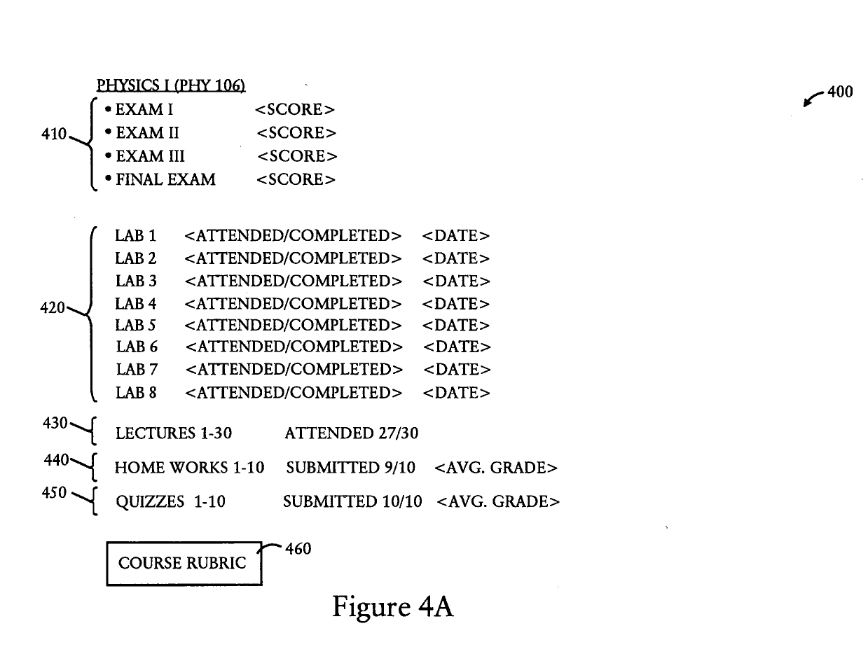

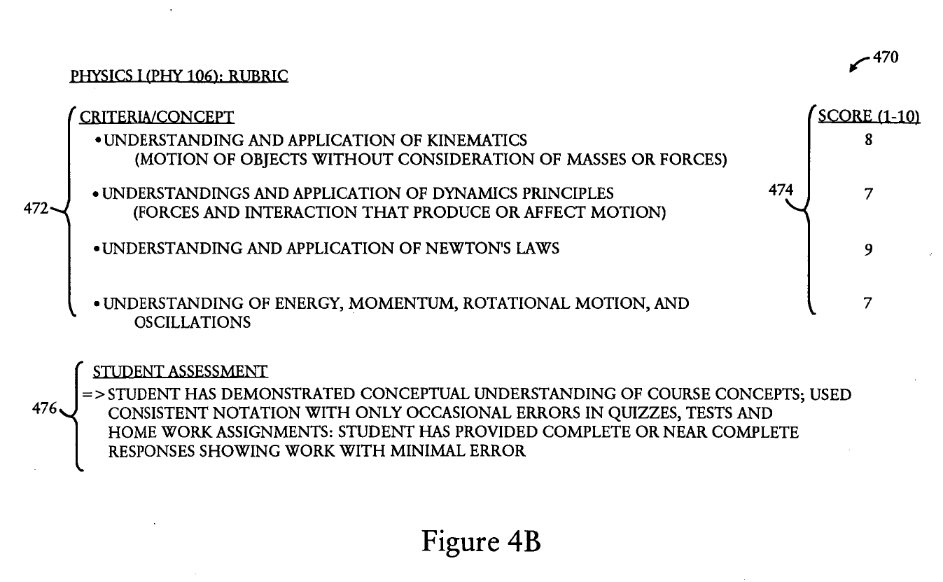

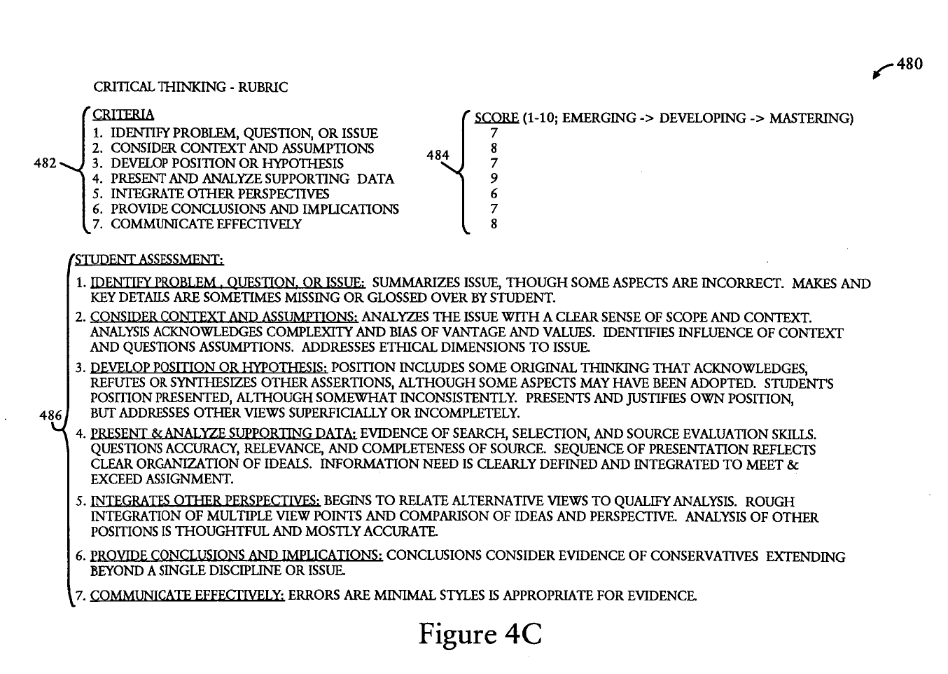

Course information 304 may provide a list of courses and grades received by a student while attending the academic institution (i.e., pre-graduation). For example, as illustrated in display 300, courses may grouped by class year (e.g., first year, freshman year, etc.) as illustrated in FIG. 3 by class years 306, 308, 310, and 312. Courses may be further grouped by semester (e.g., fall semester, spring semester), trimester, quarter, or other suitable grouping (e.g., groups 314, 316, 318, 320, 322, 326, 328, etc.). Courses may be individually selected by a user, and, upon selection computer system 102 may present additional information related to the course. For example, if user selects course 330 (i.e., Physics I) from course list 304, display 400 of FIG. 4A may be presented.

Display 400 provides information related to the student's performance in course 330 (Physics I class) shown in FIG. 3, such as number of exams and exam scores (e.g., exams 410), labs attended 420, lectures attended 430 (e.g., attended 27 out of 30 total in-class lectures), number of homework assignments submitted (e.g., homework assignments submitted electronically that identified the student) and average grade of homework assignments (e.g., homework assignments 440), number of quizzes and average quiz grade (e.g., quizzes 450), or any other suitable information. Similar data may be available for each of the courses in course list 304 of FIG. 3. The data for each course may be captured by event registration system 120 (e.g., from student identification card 122, from student digital device 124, student computer 126, etc.), from data storage 112, other campus computer systems 114, or campus academic system 116, or any combination thereof. This course data may be captured while during the pre-graduation period of student attendance at an educational institution.

Display 400 of FIG. 4A may present course rubric button 460, and, upon selection by a user, computer system 102 may present additional information related to rubrics for the Physics I course as shown in display 470 of FIG. 4B. Concepts 472 may present course concepts that a student may be scored for during the course, and upon completion of the Physics I course, may have demonstrated emerging, developing, or mastering knowledge of the identified course concepts. For example, as indicated in display 470, concepts 472 may relate to student understanding and applying concepts of kinematics, dynamics, Newton's laws, energy, motion momentum, rotational motion, and/or oscillations, or any other suitable Physics course concepts. Score 474 may indicate a score that a student has received (e.g., between 1-10 or any other suitable score, etc.) for each Physics course concept indicated in concepts 472. For example, a student may receive a score of 8 out of 10 for the student's demonstrated understanding and application of kinematics concepts.

Student assessment 476 may provide further assessment of a student's demonstrated understanding and abilities to apply course concepts for the Physics I course. For example, student assessment 476 may indicate that a student has demonstrated conceptual understanding of course concepts, used consistent notation with only occasional errors (e.g., in quizzes, tests, and/or homework assignments), and provided complete or near complete responses showing work with minimal error (e.g., on quizzes, tests, and/or homework assignments, etc.).

The rubric data for each course may be from data storage 112, other campus computer systems 114, or campus academic system 116 (e.g., as entered by a faculty member or administrator using computer 118 coupled to system 116), or any combination thereof. The rubric data may be captured while during the pre-graduation period of student attendance at an educational institution. Similar rubric data may be available for one or more criteria or concepts tested by exams 410, labs 420, lectures 430, homeworks 440, or quizzes 450, or any combination thereof. A user may select one or more items presented in exams 410, labs 420, lectures 430, homeworks 440, or quizzes 450, and computer system 102 may present one or more displays with related rubric information. Similar rubric data may also be available for one or more of the courses in course list 304 of FIG. 3.

Turning again to display 300 of FIG. 3, an administrator or other user operating user computer 104 or 118 may select drop down “rubrics” menu 331, where a user may select from one or more rubrics (e.g., rubrics for a particular course, critical thinking rubric, communication rubric, etc.). For example, an administrator or other user may select the critical thinking rubric option of “rubrics” menu 331, and computer system 102 may accordingly present critical thinking rubric display 480 of FIG. 4C. Display 480 may include criteria 482 for the critical thinking rubric, such as, for example: (1) identify the problem, question or issue; (2) consider the influence context and assumptions; (3) develop a position or hypothesis; (4) present and analyze supporting data; (5) integrate other perspectives; (6) provide conclusions and implications; and (7) communicate effectively. Criteria 482 may have one or more of the preceding exemplary elements, or may have any other suitable elements. Score 484 may indicate, for example, a score of 1-10 or any other suitable scoring range. The value of score 484 may indicate a student's emerging, developing, or mastering abilities for a particular criteria 482 of the critical thinking rubric. Student assessment 486 may provide written detail regarding a student's performance in one or more criteria area indicated in criteria 482. For example, for the criteria of identifying a problem, question, or issue, the student may be assessed as having demonstrated the ability to summarize the issue, although some aspects of the summary are incorrect and various nuances and key details may be missing or glossed over by the student.

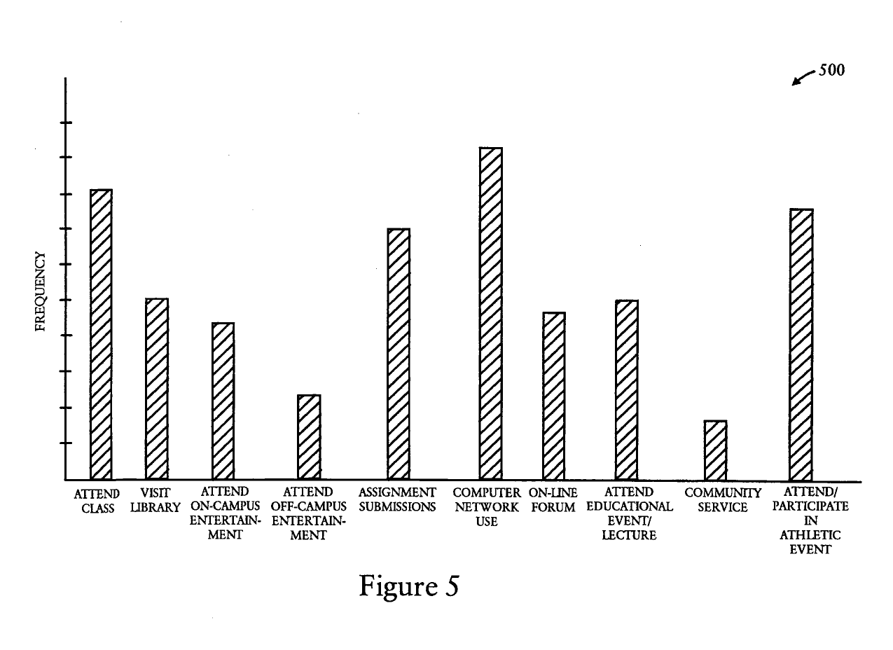

Turning again to display 300 of FIG. 3, an administrator or other user operating user computer 104 or 118 may select “pre-graduation student data graph” button 332, which may present display 500 of FIG. 5. Display 500 may be a graphical representation of captured student data registration system 120 of FIG. 1. Although data for only one student is depicted in display 400, computer system 102 may be configured to generate similar displays for a plurality of students. For example, displays may present data for students of a particular major (e.g., physics, chemistry, English, communications, engineering, etc.), of a particular class year (e.g., freshman, sophomore, junior, senior, graduate student, etc.), of a particular race or gender, or any other suitable student grouping, or any combination thereof.

As shown in display 500, the frequency of events may be collated by system 102 and presented based on one or more categories. Exemplary event frequencies that may be indicated graphically, numerically, or in any other suitable manner may include, but are not limited to: class attendance, library usage, attendance of on-campus entertainment, attendance of off-campus entertainment, class assignment submissions (e.g., using an on-line assignment submission system), computer network use (e.g., as determined by user login information), participation in on-line educational community (e.g., physics class forum, student club forum, etc.), educational event or lecture outside of class, utilization of off-campus merchant, community service, attendance or participation in athletic event, or any other suitable category, or any combination thereof. Selection of one or more of the categories may present a display that may indicate the specific breakdown of data into additional categories.

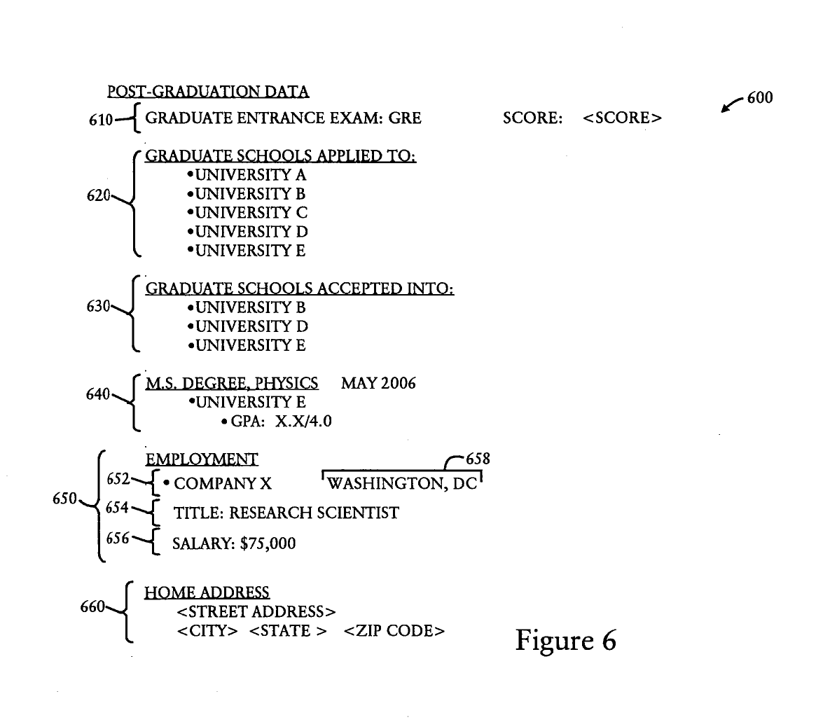

Turning again to display 300 of FIG. 3, an administrator or other user operating user computer 104 or 118 may select “post-graduation data” button 334, which may present display 600 of FIG. 6. Display 600 may present post-graduation student information including, but not limited to: graduate school examinations taken, graduate school examination scores received, graduate schools applied to, graduate schools accepted to, graduate school scholarships awarded, graduate degrees granted, date of degree grant, professional licenses obtained, names of employers, employment positions held, salary information for each position, home address, or any other suitable information. For example, the post-graduation data for an example student may have taken graduate entrance exam 610, such as the Graduate Record Exam (G.R.E.). Display 600 indicates that the former student may have applied to educational institutions 620 for graduate school, and may have been accepted by educational institutions 630. The former student may have received graduate degree 640 (e.g., Masters of Science (M.S.) in Physics, granted May 2006). The former student may also have employment history 650, that may indicate one or more employers 652, positions held 654, and salary information 656. Employment history 650 may also indicate the geographic locations of employers 658. Display 600 may also include the present home address 660 of the former student. As discussed above in connection with FIG. 1, the post-graduation data that is presented in display 600 may be captured via post-graduation self-reporting interface 128 and/or post-graduation student survey database 130 of FIG. 1.

Turning again to display 300 of FIG. 3, an administrator or other user operating user computer 104 or 118 may select “correlate data (individual)” button 336. Upon selection, computer system 102 may correlate pre-graduation student interaction data with one or more post-graduation student outcomes, as discussed above. Alternatively, computer system 102 may correlate pre-graduation student interaction data and post-graduation data with one or more post-graduation student outcomes.

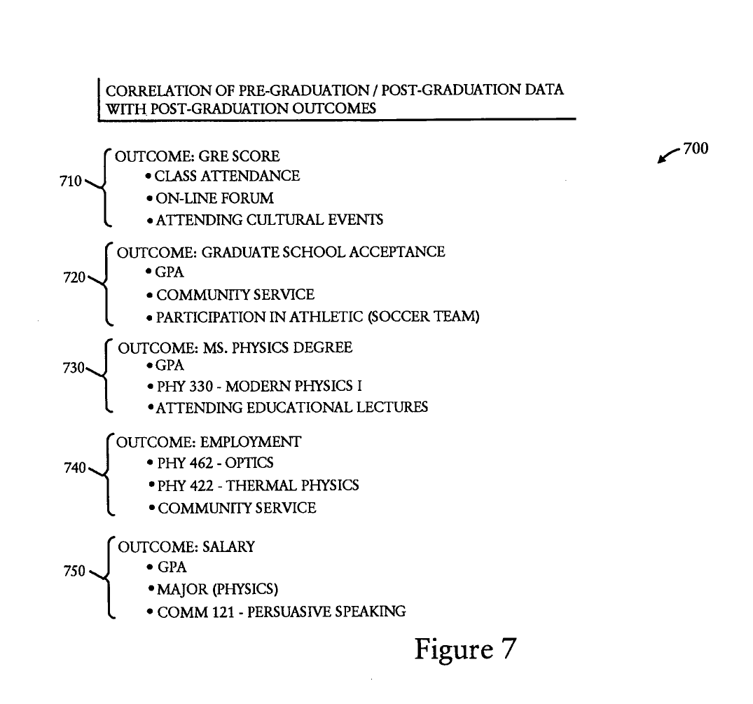

Upon selection of “correlate data (individual)” button 336, computer system 102 may present display 700 of FIG. 7. A former student may have one or more post-graduation outcomes. For example, post-graduation outcomes may include, but are not limited to: scores received for graduate school entrance examinations, graduate schools accepted to, graduate school scholarships awarded, graduate degrees granted, professional licenses obtained, names of employers, employment positions held, salary information for each position, or any other suitable information. For example, as shown in display 700, a former student may have graduate school entrance examination score outcome 710. Computer system 102 may apply factor analysis to the pre-graduation and/or post-graduation data captured, and may find increased correlation with particular pre-graduation and/or post-graduation data elements and a post-graduation outcome. Graduate school entrance examination score outcome 710, may, for example, have increased correlation with class attendance, participation in on-line community forums, and attending cultural events.

For post-graduation outcome of graduate school acceptance 720, computer system 102 may utilize data correlation applications 108 enabled with factor analysis to determine, for example, an increased correlation between grade point average (GPA), community service, and athletic participation (i.e., soccer team) and a former student's acceptance to a particular graduate school.

For post-graduation outcome of graduate degree 730, computer system 102 may utilize factor analysis of data correlation applications 108 to, for example, determine an increased correlation between GPA (grade point average), Modem Physics I class, and participation in athletics (i.e., soccer team) with the outcome of receiving an M.S. degree in Physics. For employment outcome 740, computer system 102 may determine an increased correlation between the former student's Optics and Thermal Physics classes, as well as participation in community service. For salary outcome 750, computer system 102 may determine using factor analysis that the former student's major, GPA, and persuasive speaking class had increased correlation with the salary that the former student is receiving from an employer.

Turning again to display 300 of FIG. 3, an administrator or other user operating user computer 104 or 118 may select “correlate data for groups of graduated students” button 338. Upon selection, computer system 102 may correlate pre-graduation student interaction data for a plurality of students with one or more post-graduation student outcomes, as discussed above. Alternatively, computer system 102 may correlate pre-graduation student interaction data and post-graduation data with one or more post-graduation student outcomes for a plurality of students.

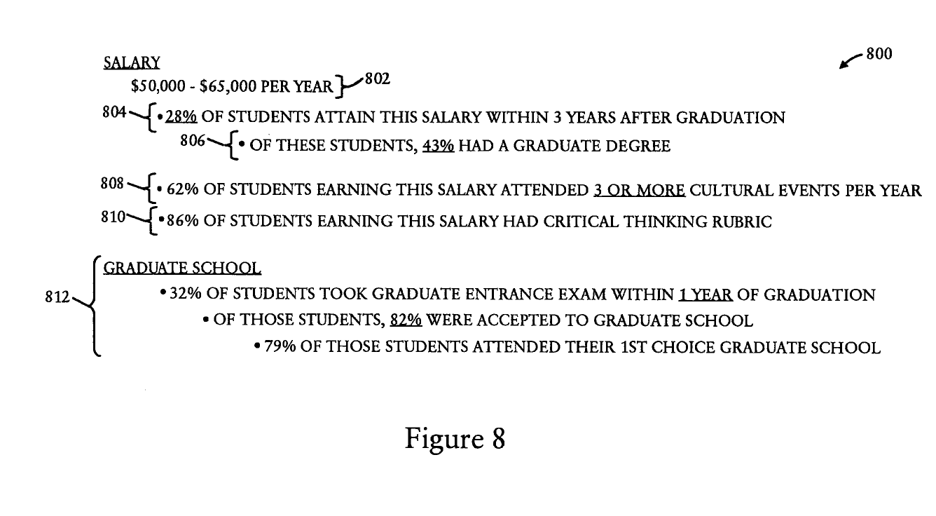

Upon selection of “correlate data for groups of graduated students” button 338, computer system 102 may present display 800 illustrated in FIG. 8. Display 800 may indicate exemplary post-graduation student data captured and its correlation to pre-graduation and/or post-graduation data by computer system 102 (e.g., using applications 108). Display 800 may indicate post-graduation salary 802 (e.g., greater that $50,000 per year, between $50,000-$65,000 per year, etc.), and post-graduation student percentage 804 (e.g., 28% of students within three years of graduating) earning post-graduation salary 802. For example, 28% of students may earn a post-graduation salary of $50,000-$65,000 within three years of graduation (e.g., based on self-reported or captured post-graduation student information as described above). Of those students earning a salary in the $50,000-$65,000, 43% may have attained a graduate degree post-graduation as indicated by graduate degree percentage 806. Display 800 may also indicate that of the post-graduation students earning income 802, 62% may have attended three or more cultural events as indicated by cultural events percentage 808. Also, as indicated by rubric percentage 810, 86% of students earning salary 802 may have had critical thinking rubric scores of 7 or greater (e.g., based on a scale of 1-10; see FIG. 4C and its related discussion above).

Display 800 may indicate other post-graduation student information such as, for example, graduate school information 812. As indicated by information 812, 32% of students graduating within the last year took a graduate entrance examination (e.g., GRE, LSAT, MCAT, GMAT, etc.). Of those students, 82% were accepted to a graduate school, with 79% of these students attending their first choice graduate school that they had been accepted to as indicated by information 812.

The detailed description set forth above in connection with the appended drawings is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details. In some instances, well known structures and components are shown in block diagram form in order to avoid obscuring the concepts of the exemplary embodiments.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for electronically correlating pre-graduation student interactions with one or more post-graduation outcomes, comprising:
capturing pre-graduation student interaction data, wherein the pre-graduation student interaction data has one or more data elements;
capturing post-graduation student data, wherein the post-graduation student data has one or more data elements;
determining the one or more post-graduation outcomes from the captured post-graduation student data;
correlating the pre-graduation student interaction data elements with the one or more post-graduation student outcomes; and
determining which captured pre-graduation student interaction data elements have increased correlation with the one or more post-graduation outcomes.

2. The method of claim 1, wherein the capturing the post-graduation student data comprises capturing employment positions attained, salary data, graduate school acceptance data, graduate schools acceptance, graduate school attendance data, graduate degrees granted data, or any combination thereof.

3. The method of claim 1, wherein the capturing post-graduation student data comprises receiving post-graduation survey data, or post-graduation self-reported data, or any combination thereof.

4 The method of claim 1, wherein the capturing post-graduation student data comprising receiving post-graduation data from systems external to an institution at which the student pre-graduation data is captured.

5. The method of claim 1, wherein the capturing the pre-graduation student interaction data comprises reading a swiped card configured with student data at an event, reading a card configured with student data with a proximity reader at an event, retrieving student data stored on an electronic device via a wired or wireless communication interchange, recording a computer login event using student identifier data, or digitally capturing student identification information from an electronically submitted communication, or any combination thereof.

6. The method of claim 5, wherein the capturing the pre-graduation student interaction data comprises capturing student presence data, non-presence data, or any combination thereof.

7. The method of claim 6, wherein the capturing of the presence data indicates student class attendance, student activity attendance, student educational event attendance, student cultural event attendance, student athletic event attendance, student participation in one or more on-line communities, student entertainment attendance, or any combination thereof.

8. The method of claim 6, wherein the capturing of non-presence data indicates student patronage of on-campus merchants, student patronage of off-campus merchants, student patronage of on-line merchants, student utilization of an on-campus resource, student utilization of an off-campus resource, student electronic submission of an assignment, or student electronic submission of student identification information, or any combination thereof.

9. The method of claim 2, wherein the determining which pre-graduation student interaction data elements have increased correlation with the one or more post-graduation student outcomes comprises applying factor analysis.

10. A system for electronically correlating pre-graduation student interactions with one or more post-graduation outcomes, comprising:
a programmable computer configured to:
capture pre-graduation student interaction data, wherein the pre-graduation student interaction data has one or more data elements;
capture post-graduation student data, wherein the post-graduation student data has one or more data elements;
determine the one or more post-graduation outcomes from the captured post-graduation student data;
correlate the pre-graduation student interaction data elements with the one or more post-graduation student outcomes; and
determining which captured pre-graduation student interaction data elements have increased correlation with the one or more post-graduation outcomes.

11. The system of claim 10, wherein the programmable computer configured to capture the post-graduation data is further configured to capture employment positions attained, salary data, graduate school acceptance data, graduate schools acceptance, graduate school attendance data, graduate degrees granted data, or any combination thereof.

12. The system of claim 10, wherein the programmable computer configured to capture the post-graduation data is further configured to receive post-graduation survey data, or post-graduation self-reported data, or any combination thereof.

13. The system of claim 10, wherein the programmable computer configured to capture the post-graduation data is further configured to interface with a system external to an institution at which the student pre-graduation data is captured to obtain the post-graduation data.

14. The system of claim 10, wherein the programmable computer configured to capture the pre-graduation student interaction data is further configured to receive card swipe data from a card configured with student data at an event, read a card configured with student data with a proximity reader at an event, receive student data stored on an electronic device via a wired or wireless communication interchange, record a computer login event using student identifier data, or any combination thereof.

15. The system of claim 14, wherein the programmable computer configured to capture the pre-graduation student interaction data is further configured to capture student presence data, non-presence data, or any combination thereof.

16. The system of claim 15, wherein the captured student presence data indicates student class attendance, student activity attendance, student educational event attendance, student cultural event attendance, student athletic event attendance, student participation in one or more on-line communities, student entertainment attendance, or any combination thereof.

17. The system of claim 15, wherein the captured non-presence data indicates student patronage of on-campus merchants, student patronage of off-campus merchants, student patronage of on-line merchants, student electronic submission of an assignment, student utilization of an on-campus resource, student utilization of an off-campus resource, or student electronic submission of student identification information, or any combination thereof.

18. The system of claim 11, wherein the programmable computer configured to determine which pre-graduation student interaction data elements have increased correlation with the post-graduation alumni giving outcomes comprises applying factor analysis.

19. Computer readable media containing programming instructions for correlating pre-graduation student interactions with one or more post-graduation alumni giving outcomes, that upon execution thereof, causes one or more processors to perform the steps of:
capturing pre-graduation student interaction data, wherein the pre-graduation student interaction data has one or more data elements;
capturing post-graduation student data, wherein the post-graduation student data has one or more data elements;
determining the one or more post-graduation alumni giving outcomes from the captured post-graduation student data;
correlating the pre-graduation student interaction data elements with the one or more post-graduation alumni giving outcomes; and
determining which captured pre-graduation student interaction data elements have increased correlation with the one or more post-graduation outcomes.

20. The computer readable media of claim 19, wherein the capturing the pre-graduation student interaction data comprises capturing employment positions attained, salary data, graduate school acceptance data, graduate schools acceptance, graduate school attendance data, graduate degrees granted data, or any combination thereof.

21. The computer readable media of claim 19, wherein the capturing post-graduation student interaction data comprises receiving post-graduation survey data, or post-graduation self-reported data, or any combination thereof.

22. The computer readable media of claim 19, wherein the capturing of the post-graduation data comprises interfacing with a system external to an institution at which the student pre-graduation data is captured to obtain the post-graduation data.

23. The computer readable media of claim 19, wherein the capturing the pre-graduation student interaction data comprises reading a swiped card configured with student data at an event, reading a card configured with student data with a proximity reader at an event, retrieving student data stored on an electronic device via a wired or wireless communication interchange, recording a computer login event using student identifier data, or digitally capturing student identification information from an electronically submitted communication, or any combination thereof.

24. The computer readable media of claim 22, wherein the capturing the pre-graduation student interaction data comprises capturing student presence data, non-presence data, or any combination thereof.

25. The computer readable media of claim 24, wherein the capturing of the presence data indicates student class attendance, student activity attendance, student educational event attendance, student cultural event attendance, student athletic event attendance, student participation in one or more on-line communities, student entertainment attendance, or any combination thereof.

26. The computer readable media of claim 24, wherein the capturing of non-presence data indicates student patronage of on-campus merchants, student patronage of off-campus merchants, student patronage of on-line merchants, student utilization of an on-campus resource, student utilization of an off-campus resource, student electronic submission of an assignment, or student electronic submission of student identification information, or any combination thereof.

27. The computer readable media of claim 19, wherein the determining which pre-graduation student interaction data elements have increased correlation with the one or more post-graduation alumni giving outcomes comprises applying factor analysis.

28. A method for electronically correlating pre-graduation student interactions with one or more post-graduation alumni giving outcomes, comprising:
capturing pre-graduation student interaction data, wherein the pre-graduation student interaction data has one or more data elements;
capturing post-graduation student data, wherein the post-graduation student data has one or more data elements;
determining the one or more post-graduation alumni giving outcomes from the captured post-graduation student data;
correlating the pre-graduation student interaction data elements and post-graduation data elements with the one or more post-graduation alumni giving outcomes; and
determining which captured pre-graduation student interaction data elements and post-graduation data elements have increased correlation with the one or more post-graduation alumni giving outcomes.
